(19) United States
(12) Patent Application Publication
(10) Pub. No.: US 2008/0025785 A1
(43) Pub. Date: Jan. 31, 2008

(54) Electric lipstick

(75) Inventors: Seog Jin Ma, Gyunggi-do (KR); Seung Bum Kim, Gyunggi-do (KR); Dae Young Kim, Gyunggi-do (KR); Hyo Young Kim, Gyunggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/806,455

(22) Filed: May 31, 2007

(30) Foreign Application Priority Data
Jul. 31, 2006 (KR) 10-2006-0072130

(51) Int. Cl. A45D 40/02; B43K 21/00

(52) U.S. Cl. 401/87; 401/55; 401/75

(57) ABSTRACT

Disclosed herein is electric lipstick. The electric lipstick includes a body for accommodating a battery therein, a lipstick container provided with a pair of guide protrusions on the circumferential surface thereof, a guide provided with a pair of guide holes formed along the length of the circumferential wall thereof so as to support the guide protrusions in a vertical direction, a rotary element provided with a pair of spiral grooves on the inner circumferential surface thereof so as to help the guide protrusions be raised and lowered as desired, a motor assembly for rotating the rotary element, and a switch for selectively connecting the motor assembly and the battery to each other and controlling the turning on, turning off, driving duration and driving direction of the motor assembly.

### CROSS REFERENCE TO RELATED APPLICATION

This application claims the benefit of Korean Patent Application No. 10-2006-0072130, filed on Jul. 31, 2006, entitled “Electric Lipstick,” which is hereby incorporated by reference in its entirety into this application.

### BACKGROUND OF THE INVENTION

1. Field of the Invention

The present invention relates generally to lipstick and, more particularly, to electric lipstick in which a lipstick material is automatically raised and lowered as desired.

2. Description of the Related Art

Lipstick is a kind of cosmetic substance that is used to decorate women's lips. Lipstick is made of a solid substance so that a user can apply it to lips directly or using a brush. Such lipstick is kept and used in a lipstick case having one of various shapes so that it can be protected from damage due to impact or contamination with foreign material. Such a lipstick case is designed to extend lipstick from the lipstick case when in use and to retract it into the lipstick case when not in use so as to allow a user to conveniently use the lipstick. Prior art lipstick is schematically illustrated in FIG. 4.

As shown in FIG. 4, lipstick 10 includes a body 20, a lipstick container 30, a rotary element 40, and a protective lid 50.

The body 20 accommodates a lipstick material therein, and includes a cylindrical part 21 and a rotary element-coupled part 22.

The cylindrical part 21 serves as a grip when in use, and is formed in a hollow cylindrical shape.

The rotary element-coupled part 22 is formed in a hollow cylindrical shape having a diameter smaller than that of the cylindrical part 21, and is provided with guide holes 23 along the length of the circumferential surface of the rotary element-coupled part 22.

The guide holes 23 guide protrusions 32, formed on the lipstick container 30, so that the lipstick container 30 can be raised and lowered as desired.

The lipstick container 30 contains a solid lipstick material 31, and is provided with a pair of protrusions 32 on the circumferential surface thereof. The protrusions 32 pass through the guide holes 23, and engage with spiral rails 41 formed in the rotary element 40.

The rotary element 40 selectively raises and lowers the lipstick container 30, and is provided with the spiral rails 41 on the circumferential surface thereof. The spiral rails 41 guide the protrusions 32 through raising and lowering operations, as desired, while the rotary element 40 is rotated.

In this case, although rotating force is applied to the protrusions 32 by the rails 41, the protrusions 32 are supported through the guide holes 32 in a vertical direction, so that the protrusions 32 move along the rails 41, thereby raising and lowering the lipstick container 30 as desired.

The protective lid 50 protects the lipstick material 31 from the outside while the lipstick 10 is not being used, and has the same outer diameter as the cylindrical part 21 of the body 20 and the same inner diameter as the rotary element 40.

However, the prior art lipstick having the above-described construction has a disadvantage in that there is the inconvenience that both hands must be used because a user must selectively raise and lower lipstick by rotating the rotary element using one hand while holding the cylindrical part using the other hand prior to the application of the lipstick.

### SUMMARY OF THE INVENTION

Accordingly, the present invention has been made keeping in mind the above problems occurring in the prior art, and the present invention is intended to provide an electric lipstick that can automatically and selectively raise and lower lipstick using a motor, so that it can be conveniently used even when it is difficult to use both hands

In order to accomplish the above object, the present invention provides electric lipstick, including a containing means for containing lipstick; a drive means for electrically generating driving force required to selectively raise and lower the containing means; and a power transmission means for transmitting the driving force to the containing means, thereby helping the containing means be raised and lowered as desired.

The containing means has a raised height that is controlled using the driving force of the drive means, which is selectively controlled.

The control of the drive means includes the control for turning on the drive means, turning off the drive means, and determining the driving duration and driving direction of the drive means.

The electric lipstick further includes an indication means for indicating the driving direction of the drive means.

The power transmission means converts the rotational driving force of the drive means into linear driving force, and transmits the linear driving force.

Additionally, the present invention provides electric lipstick, including a lipstick container for containing lipstick; a motor assembly for electrically generating rotational driving force required to selectively raise and lower the lipstick container; a rotary element for receiving the rotational driving force of the motor assembly and transmitting the rotational driving force to the lipstick container; and a guide installed in the rotary element, and configured to convert the rotational driving force, transmitted to the lipstick container, into raising or lowering force, thereby guiding the lipstick container through raising and lowering motions.

The lipstick container has a raised height that is determined by the driving duration of the motor assembly.

The electric lipstick further includes a switch for selectively applying external power to the motor assembly.

The motor assembly has a driving direction that is set to one of clockwise and counterclockwise directions by the manipulation of the switch.

The switch includes a first switch for driving the motor assembly in the clockwise direction and a second switch for driving the motor assembly in the counterclockwise direction.

The electric lipstick further includes an indication means for indicating the driving direction of the motor assembly. The indication means is light-emitting diodes.

The lipstick container has at least one pair of guide protrusions formed on a circumferential surface thereof, the rotary element has an inner circumferential surface in which spiral grooves corresponding to the guide protrusions for rotating the lipstick container are formed, and the guide has guide holes through which the guide protrusions are guided so as to selectively raise and lower the lipstick container.

The guide protrusions pass through the guide holes and engage with the spiral grooves so that the guide protrusions are selectively raised and lowered along the spiral grooves.

The spiral grooves have a height identical to a height of the guide holes.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic sectional view of electric lipstick according to a preferred embodiment of the present invention;

FIG. 2 is a perspective exploded view schematically showing the electric lipstick of FIG. 1;

FIG. 3 is a schematic perspective view showing the operation of the electric lipstick of FIG. 1; and

FIG. 4 is a perspective exploded view schematically showing prior art lipstick.

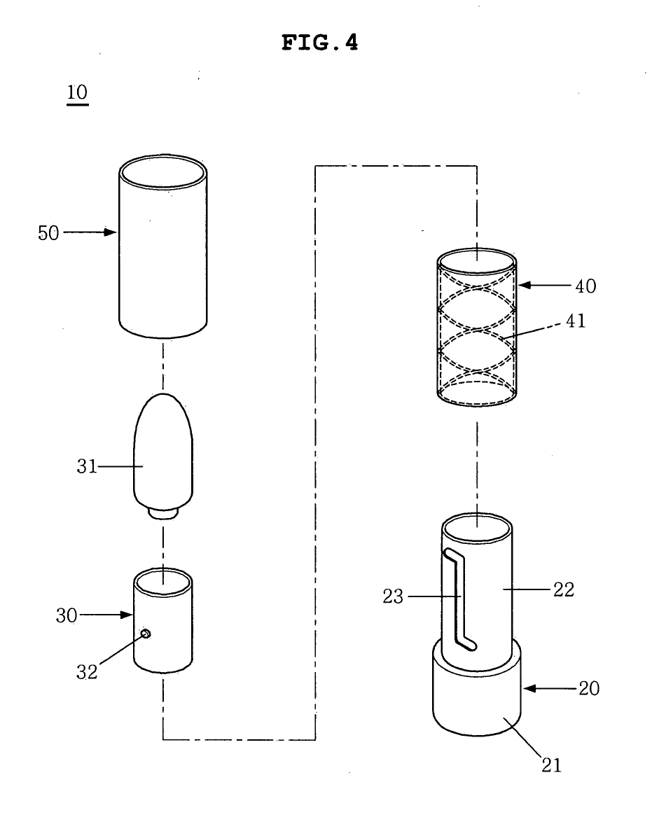

### DESCRIPTION OF THE PREFERRED EMBODIMENTS

Reference now should be made to the drawings, in which the same reference numerals are used throughout the different drawings to designate the same or similar components.

Electric lipstick 100 according to a preferred embodiment of the present invention will be described in detail below.

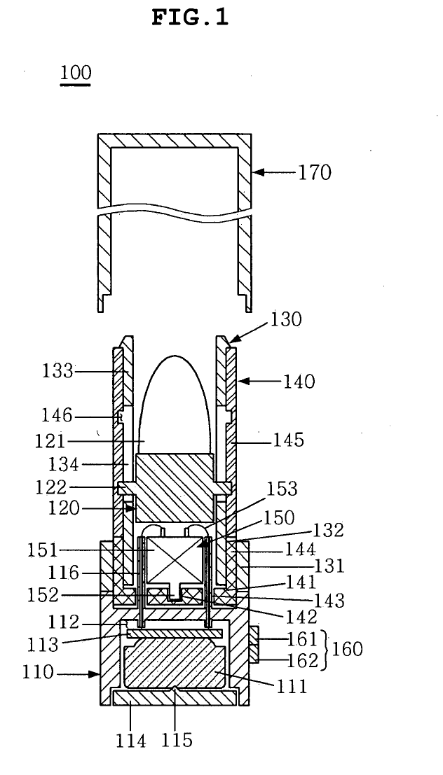

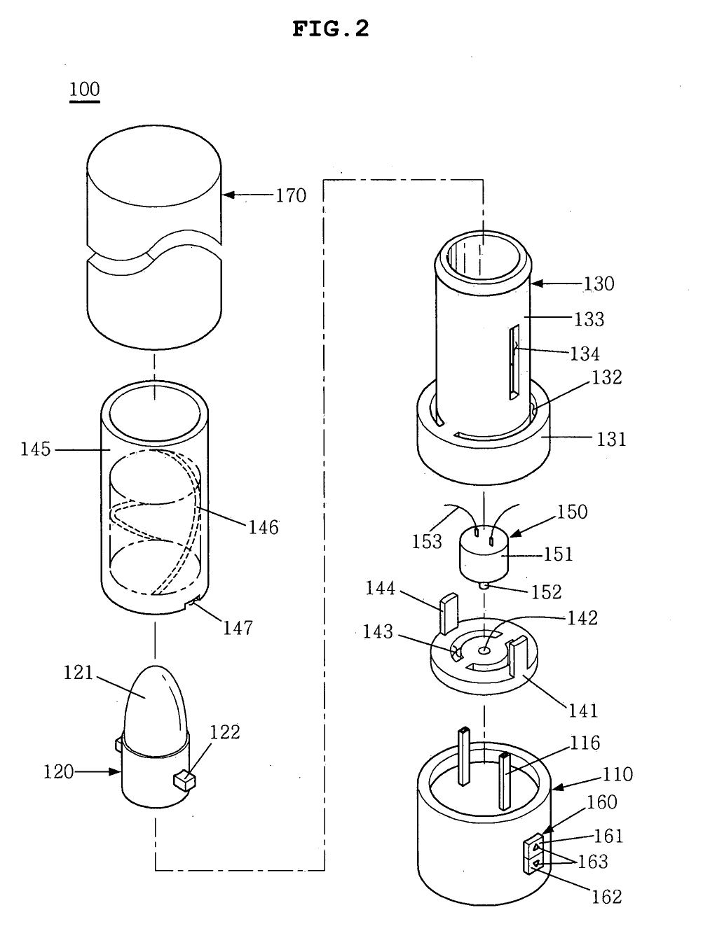

As shown in FIGS. 1 and 2, the electric lipstick 100 according to the preferred embodiment of the present invention includes a body 110, a lipstick container 120, a guide 130, a rotary element 140, a motor assembly 150, a switch 160, and a protective lid 170.

The body 110 accommodates a battery 111 therein, serves as a grip while the electric lipstick 100 is used, and has a battery accommodation cavity 112 configured to be open toward the lower end of the body 110 and a pair of motor fastening protrusions 116 formed on the upper end of the body 110.

The battery accommodation cavity 112 contains the battery 111 for driving the motor assembly 150. A circuit board 113 for electrically connecting the battery 111 with the motor assembly 150 is fastened inside the battery accommodation cavity 112.

The circuit board 113 is formed of a flexible board, is electrically connected to one electrode of the battery 111, the switch 160 and the motor assembly 150, and is provided with an electric circuit for controlling the motor assembly 150.

A lid 114 is removably placed under the battery accommodation cavity 112 so as to prevent the battery 111 from falling out of the battery accommodation cavity 112.

The lid 114 is coupled with the body 110 so as to close the battery accommodation cavity 112. Here, the lid 114 may be coupled with the body 110 in a screw manner or a tight fitting manner. The lid 114 is provided with a brush 115 that is electrically connected to the other electrode of the battery 111. The brush 115 is electrically connected to the circuit board 113.

The motor fastening protrusions 116 are used to firmly hold the motor assembly 150, are formed of a pair of opposite parts, and protrude through the first rotary element 141 and come into tight contact with the circumferential surface of the motor assembly 150. The motor fastening protrusions 116 are formed to be hollow, and a pair of electrical wires 153 is electrically connected to the circuit board 113 via the central holes of the pair of motor fastening protrusions 116 so as to conduct electricity to the motor assembly 150. Here, the motor fastening protrusions 116 firmly hold the motor assembly 150. In an embodiment, the volume of or area of the sections of the motor fastening protrusions 116 is designed to be as small as possible in order not to impede the rotation of the first rotary element 141.

The lipstick container 120 is a containing means for containing a lipstick material 121, and is provided with a pair of protrusions 122 on the circumferential surface thereof.

The guide 130 is formed to be hollow, and includes a body-coupled part 131 and a rotary element-coupled part 133.

The body-coupled part 131 is formed in a hollow cylindrical shape having the same diameter as that of the body 110, and is fastened to the upper surface of the body 110 on the lower surface of the body-coupled part 131. In an embodiment, the body-coupled part 131 is bonded to the body 110 via a specific bonding means.

The body-coupled part 131 has a pair of opposite semi-annular through holes 132 so that the rotary element fastening protrusion 144 of the first rotary element 141 passes through the body-coupled part 131 and is engaged with the rotary element fastening depressions 147 of the second rotary element 145.

The rotary element-coupled part 133 is formed in a hollow cylindrical shape having a diameter smaller than that of the body 110 and that of the body-coupled part 131, and is provided with a pair of guide holes 134 along the length of the circumferential wall of the rotary element-coupled part 133.

The guide holes 134 support the guide protrusions 122 in a vertical direction so as to prevent the lipstick container 120 from being rotated along the second rotary element 145 while the second rotary element 145 is rotated.

The rotary element 140 receives the rotating force of the motor assembly 150 and transmits the rotating force to the lipstick container, and includes the first rotary element 141 and the second rotary element 145.

The first rotary element 141 is formed in a disk shape having a diameter smaller than that of the body 110, and includes a rotating shaft fitting depression 142, fastening holes 143, and rotary element fastening protrusions 144.

The rotating shaft fitting depression 142 is formed at the center of the first rotary element 141, and is firmed engaged with the rotating shaft 152 so that the first rotary element 141 is rotated while the motor assembly 150 is driven.

The fastening holes 143 form a pair so that they face each other around the rotating shaft fitting depression 142. In an embodiment, the fastening holes 143 have a semi-annular shape to correspond to the through holes 132 of the guide 130. The motor fastening protrusions 116 protrude through the fastening holes 143 toward the motor assembly 150, and fasten the motor assembly 150.

The rotary element fastening protrusions 144 form a pair, are formed on the circumference of the first rotary element 141, and are fastened to the second rotary element 145 through the through holes 132 of the guide 130.

The second rotary element 145 is formed in a hollow cylindrical shape, and is coupled to the rotary element-coupled part 133 of the guide 130. In an embodiment, the second rotary element 145 is formed to have approximately the same inner diameter as that of the rotary element-coupled part 133. The second rotary element 145 is provided with a pair of opposite spiral grooves 146.

The spiral grooves 146 are vertically formed along the inner circumferential surface of the second rotary element 145 so as to guide the guide protrusions 122 through raising and lowering motions while the second rotary element 145 is rotated. In an embodiment, the guide grooves 146 may be formed so that the two ends thereof face each other around the central axis of the second rotary element 145 in a diagonal direction. In an embodiment, the spiral grooves 146 may have the same height as the guide holes 134.

The second rotary element 145 is provided with the rotary element fastening depressions 147 on the lower end of the second rotary element 145 so as to correspond to the rotary element fastening protrusions 144.

The rotary element fastening depressions 147 engage with the rotary element fastening protrusions 144 passing through the guide 130, and rotate the second rotary element 145 when the first rotary element 141 is rotated.

The motor assembly 150 is a drive means for electrically generating rotating force required to selectively raise and lower the lipstick container 120, and includes a cylindrical body 151 and a rotating shaft 152.

The cylindrical body 151 has an outer diameter identical to the distance between the pair of motor fastening protrusions 116, and is tightly fitted into the motor fastening protrusions 116. Although, in an embodiment, the cylindrical body 151 may be bonded to the motor fastening protrusions 116, the cylindrical body 151 may be coupled using another coupling means.

Although not shown in detail, the cylindrical body 151 contains a motor and a plurality of planetary gears, so that the appropriate rotating force required to raise and lower the lipstick container 120 as desired can be obtained.

The rotating shaft 152 is tightly fitted into the rotating shaft fitting depression 142 of the first rotary element 141, and rotates the first rotary element 141 clockwise or counterclockwise.

The switch 160 selectively applies the electricity of the battery 111 to the motor assembly 150, and is electrically connected to the circuit board 113.

The switch 160 controls the driving of the motor assembly 150 and the rotational direction of the rotating shaft 152, and have control states, including a stop state, a forward drive state and a reverse drive state, according to the driving of the motor assembly 150.

In the present embodiment, the switch 160 includes a first switch 161 and a second switch 162, which are used independently of each other.

In the case where neither of the first and second switches 161 and 162 is pressed, the motor assembly 150 is not driven, and is in a stop state. In the case where the first switch 161 is pressed, the motor assembly 150 is driven to raise the lipstick container 120, and is in a forward drive state. Meanwhile, in the case where the second switch 162 is pressed, the motor assembly 150 is driven to lower the lipstick container 120, and is in a reverse drive state.

Although, in the present embodiment, the push button-type switches 160 are used, other types of switches may be used, as long as they can perform control related to a stop state, a forward drive state, and a reverse drive state.

The electric lipstick 100 further includes Light-Emitting Diodes (LEDs) 163 as an indication means for indicating the direction of the rotating shaft 152 outside the electric lipstick 100. In the present embodiment, the LEDs 163 are respectively contained in the first and second switches 161 and 162. Alternatively, the LEDs 162 may be installed on the circumferential surface of the body 110. In an embodiment, the LEDs 163 may radiate light having different colors in order to allow a user to easily identify the rotating direction of the rotating shaft 152, that is, whether the lipstick container 120 is being raised or lowered.

The protective lid 170 protects the lipstick material 121 from the outside while the electric lipstick 100 is not used, and has the same outer diameter as the body-coupled part 131 and the same inner diameter as the rotary element 145.

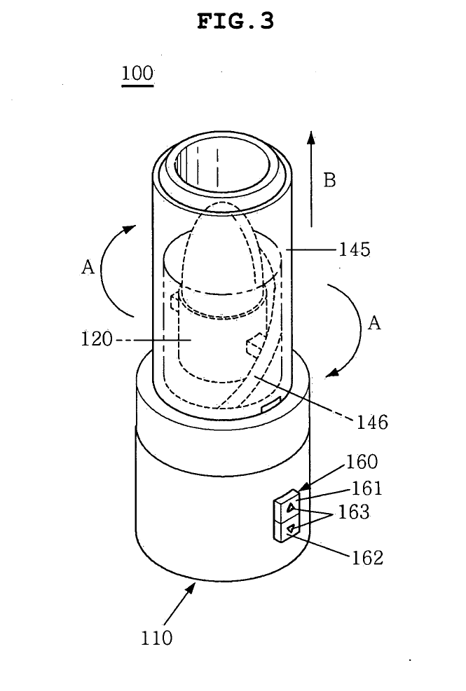

The electric lipstick 100 having the above-described structure is operated with reference to FIG. 3 as described below.

When the user presses the first switch 161 in the case where the electric lipstick 100 is used to apply the lipstick material 121 to the lips, the motor assembly is driven, so that the second rotary element 145 is rotated in the direction of the arrow A, and thus the lipstick container 120 moves in the direction of the arrow B along the spiral groove 146 and the vertical guide groove.

Meanwhile, when the user presses the second switch 162, the motor assembly is driven in the reverse direction, and thus the second rotary element 145 is rotated in the direction opposite the direction of arrow A, so that the lipstick container 120 moves in the direction opposite the direction of arrow B, that is, it is retracted into the guide.

In this case, although all of the lipstick material 121 is exposed to the outside when the first switch 161 is continuously pressed, the raised height of the lipstick container 120, that is, the degree of exposure of the lipstick material 121, can be controlled by alternately pressing the first switch 161 and the second switch 162.

In accordance with the electric lipstick according to the present invention, lipstick is automatically raised and lowered using an electrically operated motor assembly, therefore the lipstick can be conveniently applied to the lips even when both hands cannot be used at the same time.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. Electric lipstick, comprising:
containing means for containing lipstick;
drive means for electrically generating driving force required to selectively raise and lower the containing means; and
power transmission means for transmitting the driving force to the containing means, thereby helping the containing means be raised and lowered as desired.

2. The electric lipstick as set forth in claim 1, wherein the containing means has a raised height that is controlled using the driving force of the drive means, which is selectively controlled.

3. The electric lipstick as set forth in claim 2, wherein the control of the drive means comprises control for turning on the drive means, turning off the drive means, and determining a driving duration and a driving direction of the drive means.

4. The electric lipstick as set forth in claim 3, further comprising indication means for indicating the driving direction of the drive means.

5. The electric lipstick as set forth in claim 1, wherein the power transmission means converts rotational driving force of the drive means into linear driving force, and transmits the linear driving force.

6. Electric lipstick, comprising:
a lipstick container for containing lipstick;
a motor assembly for electrically generating rotational driving force required to selectively raise and lower the lipstick container;
a rotary element for receiving the rotational driving force of the motor assembly and transmitting the rotational driving force to the lipstick container; and
a guide installed in the rotary element, and configured to convert the rotational driving force, transmitted to the lipstick container, into raising or lowering force, thereby guiding the lipstick container through raising and lowering motions.

7. The electric lipstick as set forth in claim 6, wherein the lipstick container has a raised height that is determined by a driving duration of the motor assembly.

8. The electric lipstick as set forth in claim 7, further comprising a switch for selectively applying external power to the motor assembly.

9. The electric lipstick as set forth in claim 8, wherein the motor assembly has a driving direction that is set to one of clockwise and counterclockwise directions by manipulation of the switch.

10. The electric lipstick as set forth in claim 9, wherein the switch comprises a first switch for driving the motor assembly in the clockwise direction and a second switch for driving the motor assembly in the counterclockwise direction.

11. The electric lipstick as set forth in claim 9, further comprising indication means for indicating a driving direction of the motor assembly.

12. The electric lipstick as set forth in claim 11, wherein the indication means is light-emitting diodes.

13. The electric lipstick as set forth in claim 6, wherein:
the lipstick container has at least one pair of guide protrusions formed on a circumferential surface thereof;
the rotary element has an inner circumferential surface in which spiral grooves corresponding to the guide protrusions for rotating the lipstick container are formed; and
the guide has guide holes through which the guide protrusions are guided so as to selectively raise and lower the lipstick container.

14. The electric lipstick as set forth in claim 13, wherein the guide protrusions pass through the guide holes and engage with the spiral grooves so that the guide protrusions are selectively raised and lowered along the spiral grooves.

15. The electric lipstick as set forth in claim 14, wherein the spiral grooves have a height identical to a height of the guide holes.
